(19) United States
(12) Patent Application Publication
(10) Pub. No.: US 2026/0005983 A1
(43) Pub. Date: Jan. 1, 2026

(54) IOT EDGE SYSTEM FOR SHARING RESOURCES AMONG IOT EDGES HAVING HIERARCHICAL STRUCTURE

(71) Applicants: Seoul National University R&DB Foundation, Seoul (KR); MySmaX Co., Ltd., Seoul (KR)

(72) Inventors: Soonhoi HA, Seoul (KR); Euiseok KIM, Seoul (KR); Taehyeong SON, Seoul (KR)

(73) Assignees: Seoul National University R&DB Foundation, Seoul (KR); MySmaX Co., Ltd., Seoul (KR)

(21) Appl. No.: 19/241,436

(22) Filed: Jun. 18, 2025

(30) Foreign Application Priority Data
Jun. 28, 2024 (KR) 10-2024-0085601

(51) Int. Cl. H04L 47/78

(52) U.S. Cl. CPC H04L 47/782

(57) ABSTRACT

An Internet of Things (IoT) edge system enables resource sharing among hierarchically structured IoT edges. The system includes IoT devices that register service lists with IoT edge devices in the same network and process service execution requests. Each IoT edge device includes middleware that manages services, sets publication status, and controls access rights. The IoT edge devices form a tree-shaped hierarchical structure where higher-layer devices receive published service lists from lower layers and have access rights to those services. Higher-layer devices can generate super services by combining services from multiple layers, enabling efficient resource utilization across the hierarchical IoT network.

### CROSS-REFERENCE TO RELATED APPLICATION(S)

This application claims priority from Korean Patent Application No. 10-2024-0085601, filed on Jun. 28, 2024, in the Korean Intellectual Property Office, the disclosure of which is incorporated herein by reference in its entirety.

### BACKGROUND

### 1. Field

The following description relates to a service-based Internet of Things (IoT) platform, and more particularly, to a technology for sharing resources among IoT edges having a hierarchical structure.

### 2. Description of Related Art

The Internet of Things (IoT) is gradually becoming pervasive in our daily lives, and hundreds of IoT platforms are under development to keep up with this IoT growth. IoT platforms are software frameworks that enable the management and connection of various smart devices and applications over the Internet, acting as a bridge between layers of an IoT system which range from the device layer to the application layer.

IoT platforms may be broadly categorized into cloud-based and edge-based types on the basis of the location of middleware. Cloud-based platforms deploy platform-as-a-service (PaaS) middleware in the cloud and connect IoT devices over an Internet network. Cloud-based platforms are more popular because of their ease of implementation, low cost, and extensibility. On the other hand, edge-based platforms have several advantages over cloud-based platforms by providing the functions of cloud computing to edge devices. Edge-based IoT platforms do not need to transmit data to the cloud and thus show low latency and improved responsiveness and additionally have security benefits. Also, edge-based IoT platforms can continuously operate even when network conditions are poor.

Edge-based IoT platforms are emerging to address extensibility issues by providing a mesh network for interconnectivity between edges. However, with an increase in the number of edges, this mesh-like interconnection between edges has the problem of rapidly increasing management complexity. This limits the application of mesh-like interconnection to small IoT systems such as smart homes.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. The following description relates to providing an Internet of Things (IoT) edge system that is easily extended by connecting edge-based IoT platforms in a tree-shaped hierarchical structure.

The following description also relates to providing an IoT edge system in which middleware of a higher layer in a hierarchical structure utilizes a service published by middleware of a lower layer to generate and share a new high-level service.

Technical objects to be achieved in the present invention are not limited to those described above, and other technical objects that have not been described will be clearly understood by those of ordinary skill in the art from the following description.

In one general aspect, an IoT edge system in which IoT edges having a hierarchical structure share resources includes a plurality of IoT devices and a plurality of IoT edge devices.

The IoT devices register a list of providable services with the IoT edge devices in the same network and receive service execution requests from the IoT edge devices to process the service execution requests.

Each of the IoT edge devices includes middleware that registers and manages services provided by an IoT device in the same network, sets whether to publish the registered services, and determines whether to provide a service depending on an access right when another IoT edge device requests a service.

The plurality of IoT edge devices form a tree-shaped hierarchical structure. An IoT edge device having a higher layer forwards a list of published services to an IoT edge device in the higher layer, and the IoT edge device in the higher layer has the right to access the services published by the IoT edge device in a lower layer.

The IoT edge device in the higher layer may generate a super service by combining a service registered with the IoT edge device with a service published by the IoT edge device in the lower layer or combining services published by the IoT device in the lower layer.

The IoT edge device generating the super service may set the super service public and forward the generated super service to IoT edge devices in the lower layer of the IoT edge device.

The IoT edge device generating the super service may generate a virtual IoT device which will execute the super service, register the virtual IoT device with middleware of the IoT edge device, and when a super service request is received, execute the super service through the virtual IoT device to process the service.

When failing to execute one service constituting the super service, the IoT edge device processing the requested super service may stop execution of the super service and notify an IoT edge device which has requested the super service of the failure in processing the super service.

When the IoT edge device which processes the requested super service fails to execute a service constituting the super service and the same service is provided by another IoT edge device, the IoT edge device may request execution of the service that the IoT edge device has failed to execute from the other IoT edge device which provides the same service.

When a service constituting the super service is provided in the same way by a plurality of IoT edge devices, the IoT edge device processing the requested super service may request processing of the service such that the service constituting the super service may be executed by the plurality of IoT edge devices in a distributed manner.

Each of the IoT edge devices may dynamically manage an execution state of a service provided by the IoT edge device and report the execution state in response to a service execution state report request received from an IoT edge device in a higher layer.

The IoT edge device in the higher layer that requests execution of the service published by the IoT edge device in the lower layer may check availability of the service from the IoT edge device in the lower layer before requesting the execution of the service.

An IoT edge device that executes the super service may check availability of all the services constituting the super service and then start executing the super service.

Other features and aspects will be apparent from the following detailed description, the drawings, and the claims.

### BRIEF DESCRIPTION OF THE DRAWINGS

FIG. 1 is a conceptual diagram of an Internet of Things (IoT) edge system with a hierarchical structure among IoT edges according to the present invention.

FIG. 2 is a conceptual diagram illustrating a super service based on resource sharing among IoT edges.

FIG. 3 is a conceptual diagram illustrating an execution process of a super service based on resource sharing among IoT edges.

### DETAILED DESCRIPTION

The above-described and additional aspects will be specified through exemplary embodiments described with reference to the accompanying drawings. It will be understood that components of each of the embodiments may be variously combined within the embodiment unless otherwise stated or contradicted. Each block of block diagrams may represent a physical part in some cases, or may be a logical representation of some functions of one physical part or a function of a plurality of physical parts in other cases. In some cases, the entity of a block or a part of the block may be a set of program instructions. All or some of these blocks may be implemented as hardware, software, or a combination thereof.

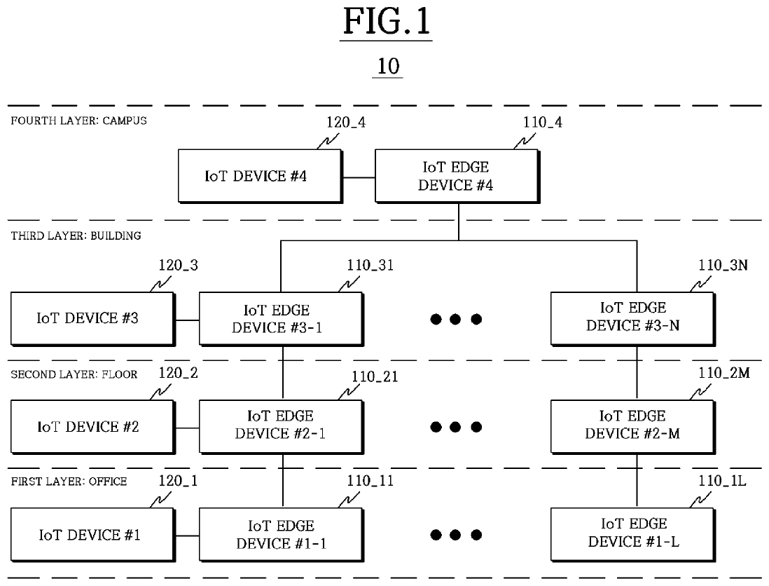

FIG. 1 is a conceptual diagram of an Internet of Things (IoT) edge system with a hierarchical structure among IoT edges according to the present invention. An IoT edge system 10 according to an aspect of the present invention is a system for sharing resources among IoT edges having a hierarchical structure and includes a plurality of IoT devices 120 and a plurality of IoT edge devices 110.

The IoT edge system 10 of the present invention is an edge-based platform.

The IoT devices 120 are hardware devices that are controlled or exchange data via a network such as sensors, home appliances, and other machines. The IoT devices 120 of the present invention generate service lists from providable services and register the service lists with the IoT edge devices 110 in the same network.

The IoT devices 120 receive service execution requests from the IoT edge devices 110 and process, that is, execute, the services.

The IoT edge system 10 of the present invention easily addresses the problem of system extensibility by employing a hierarchical structure of the IoT edge devices 110. As shown in the example of FIG. 1, IoT edge devices 110_1X, 110_2X, 110_3X, and 110_4 form a tree-shared hierarchical structure.

The IoT edge devices 110 may be hub devices with computing capability. The IoT edge devices 110 include middleware, which has a hierarchical structure. When the middleware is connected in a hierarchical structure, the hierarchical structure of the IoT edge devices 110 is formed. The middleware relays all communication of the IoT devices 120 that are geographically close to each other and thus use the same network, thereby implementing a smart office, a smart home, or the like.

The middleware searches for the IoT devices 120 in the same network and registers and manages services provided by the found IoT devices 120.

The IoT edge devices 110 abstract functions provided by the IoT devices 120 as services and provide the services. Here, the services may be abstracted in the form of application programs that are written in a scripting language or a programming language and implemented. A user or the like may request a service using an identifier of an IoT device 120 and/or a service identifier (e.g., a service name). An IoT edge device 110 executes the service and gives the IoT device 120 a control command related to service execution to control the IoT device 120.

Here, the middleware maps the IoT devices 120 to the services provided by the IoT devices 120 and manages them. For example, the middleware may map device identifiers (e.g., device identifications (IDs)) to service identifiers (e.g., service names) and manage them.

The middleware may generate a composite service which is a new service by combining services registered with the middleware.

In addition, the middleware sets whether to publish registered services. The IoT edge devices 110 provide a user interface for setting whether to publish a service such that a user or a manager may set a service public using the interface. Here, there is no limitation on the way the user interface provided by the IoT edge devices 110 is implemented.

According to the present invention, a service published by middleware in a lower layer is executable by middleware in higher layers on a path from the corresponding layer to the highest layer. The middleware in the higher layers may execute the service published by the middleware in the lower layer but is prevented from accessing data required for executing the service.

Middleware determines whether there is a higher layer of the middleware, and when it is determined that there is a higher layer, forwards a list of services which are set public to middleware in the higher layer. In other words, an IoT edge device 110 having a higher layer forwards a list of published services to an IoT edge device 110 of the higher layer. The middleware in the higher layer receiving the list of published services from the middleware in the lower layer may register and manage services received from the lower layer separately from services registered therewith.

In addition, when there is a service request from another IoT edge device 110, middleware determines whether the other IoT edge device 110 which has requested the corresponding service has an access right, that is, determines whether to provide the service depending on the access right. Here, IoT edge devices 110 in higher layers on a path from a lower layer to the highest layer have the right to access services published by an IoT edge device 110 in the lower layer.

The example of FIG. 1 has a hierarchical structure in which IoT edge devices are classified into four layers. The first layer is a layer of one office, the second layer is a layer of one floor, the third layer is a layer of one building, and the fourth layer is a layer of a campus including multiple buildings. A service published by IoT edge device #1-1 (110_11) is accessible to IoT edge device #2-1 (110_21), IoT edge device #3-1 (110_31), and IoT edge device #4-1 (110_4) in higher layers, but is inaccessible to IoT edge device #1-L (110_1L), IoT edge device #2-M (110_2M), and IoT edge device #3-N (110_3N).

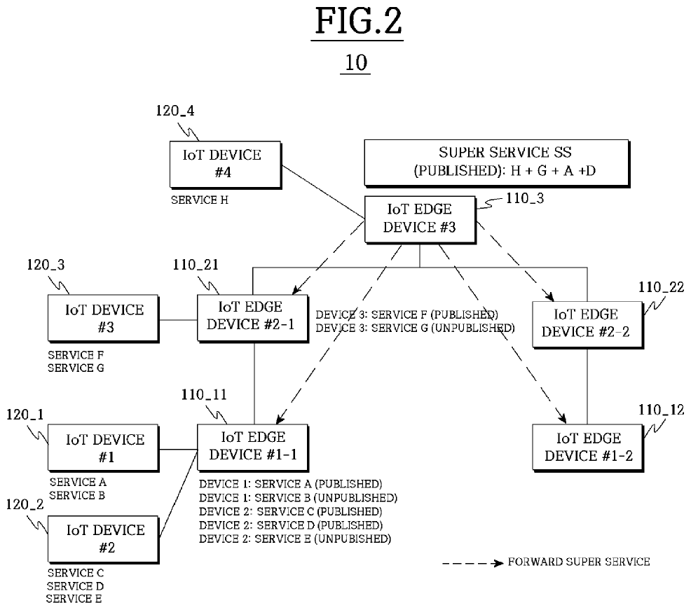

FIG. 2 is a conceptual diagram illustrating a super service based on resource sharing among IoT edges. According to an aspect of the present invention, an IoT edge device 110 in a higher layer generates a super service by combining a service registered with the IoT edge device 110 and a service published by an IoT edge device 110 in a lower layer or combining services published by an IoT edge device 110 in a lower layer.

In other words, a super service is a new composite service that is generated using, as shared resources, IoT devices 120 that have been registered with IoT edge devices 110 in lower layers and published. A super service is an application program written in a scripting language or a programming language. A super service may be generated by middleware in a layer other than the lowest layer, and when a higher layer requires a service of a lower layer, that is, resources of the lower layer, a super service may be generated and used.

Here, the IoT edge device 110 generating the super service may set the super service public. In other words, middleware generating the super service may publish the generated super service. The IoT edge device 110 publishing the super service may forward the generated super service to IoT edge devices 110 in lower layers thereof. This may be performed through communication between middleware and processed by forwarding the service name of the super service.

An example of generating a super service will be described with reference to FIG. 2. Among IoT edge devices forming the hierarchical structure of FIG. 2, IoT edge device #1-1 (110_11) in the lowest layer registers and manages IoT device #1 (120_1) providing services A and B and IoT device #2 (120_2) providing services C, D, and E. IoT edge device #1-1 (110_11) sets service A of IoT device #1 (120_1) and services C and D of IoT device #2 (120_2) public. A list of the published services A, C, and D is forwarded to IoT edge device #2-1 (110_21) and IoT edge device #3 (110_3) in upper layers. IoT edge device #2-1 (110_21) registers and manages IoT device #3 (120_3) providing services F and G and sets service F public. In FIG. 2, IoT edge device #3 (110_3) in the highest layer registers and manages IoT device #4 (120_4) providing service H and generates and publishes super service SS including service H, service G, service A, and service D. The published super service SS is forwarded to all the IoT edge devices 110_11, 110_12, 110_21, and 110_22 in lower layers of IoT edge device #3 (110_3).

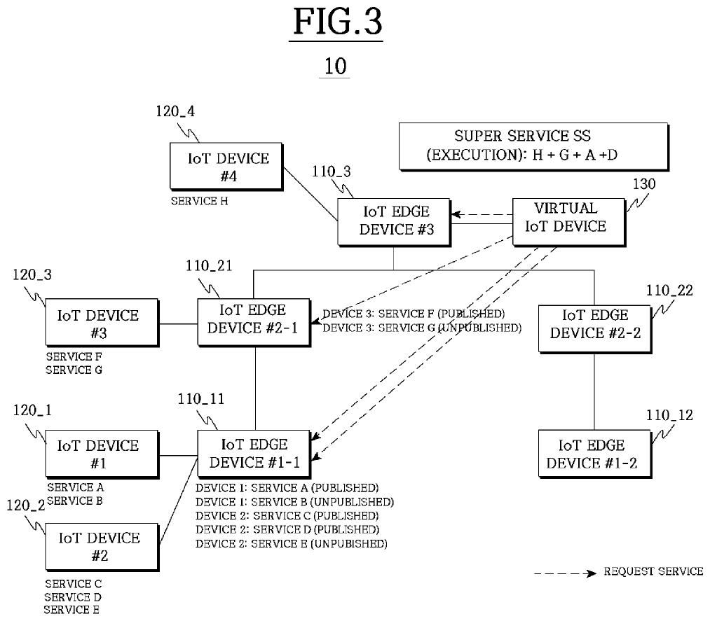

FIG. 3 is a conceptual diagram illustrating an execution process of a super service based on resource sharing among IoT edges. According to an aspect of the present invention, an IoT edge device 110 generating a super service generates a virtual IoT device 130 which will execute the super service, registers the virtual IoT device 130 with middleware thereof, and when a super service request is received, executes the super service through the virtual IoT device 130 to process the service.

According to the present invention, since functions of IoT devices are mapped to services, abstracted, and used, a super service requires an IoT device for mapping. According to the present invention, an IoT device which will be mapped to a super service is virtually generated and registered with middleware in the same way as general IoT devices.

The virtual IoT device 130 may be an application program that executes the super service. For example, when the super service is implemented in a scripting language, the virtual IoT device 130 may be a program of which execution is controlled by the syntax of the scripting language.

When middleware requests execution of the super service, the virtual IoT device 130 executes the mapped super service. For services constituting the super service, the virtual IoT device 130 requests execution of the services from IoT edge devices with which the services have been registered, through the middleware of the IoT edge device 110 having registered the virtual IoT device 130 and receives the results.

An example of executing a super service will be described with reference to FIG. 3. IoT edge device #3 (110_3) of FIG. 3 generates a virtual IoT device 130 to execute super service SS, and the virtual IoT device 130 executes super service SS. As described above, super service SS may be an application program. The virtual IoT device 130 requests each service constituting super service SS to execute super service SS. Here, the super service execution request may be made by IoT edge device #3 (110_3) or another IoT edge device in a lower layer. The virtual IoT device 130 requests IoT edge device #3 (110_3) to execute service H among services constituting super service SS and requests IoT edge device #2-1 (110_21) to execute service G through the middleware of IoT edge device #3 (110_3).

Each individual service included in a super service may be a service of an IoT device connected to an IoT edge device in another place, and in this case, IoT devices may be dynamically removed or become unavailable for service due to failure or the like. Therefore, when the super service is executed, the services included in the super service may fail to run.

A super service may be executed when an IoT edge device generating the super service requests the super service or an IoT edge device in a lower layer requests the published super service.

When one service constituting a super service fails to run, an IoT edge device which processes the requested super service may stop execution of the super service and notify an IoT edge device which has requested the super service of the failure in processing the super service. For example, when the IoT edge device which has generated the super service makes the request, the virtual IoT device may notify the middleware of the failure in processing the super service, and when the IoT edge device in a lower layer makes the request, the virtual IoT device may notify the middleware of the failure in processing the super service, and the middleware may forward the failure to the middleware of the IoT edge device in the lower layer. Here, the notification of the failure in processing the super service may include a service identifier (e.g., a service name) of a service that the super service has failed to run and identifier information of an IoT device mapped to the corresponding service.

In an IoT edge system in which a hierarchical structure is formed, a plurality of identical IoT devices may be registered with different IoT edge devices or the same IoT edge device and used.

When a service constituting a super service fails to run and the same service is provided by another IoT edge device, an IoT edge device which processes the requested super service may request the other IoT edge device which provides the same service to execute the service which has failed to run. In other words, when a plurality of IoT devices provide a specific service in the same way in an IoT edge system, it is possible to request another IoT edge device which provides the service to execute the service without stopping execution of the super service irrespective of a failure in executing the service.

Here, the other IoT edge device is required to publish the service, and the IoT edge device which generates the super service is required to be in a higher layer than the other IoT edge device and thus have an access right. In other words, when IoT edge devices providing the same service are in lower layers than an IoT edge device generating a super service in a higher layer and each of the IoT edge devices in the lower layers sets the service public, the service is forwarded to the IoT edge device in the higher layer generating the super service.

Even when a specific service fails to run, a virtual IoT device which executes a super service does not stop the super service and checks whether there is another IoT edge device providing the same service mapped by middleware, and then, when there is another IoT edge device, requests the same service from the other IoT edge device. According to an aspect of the present invention, when middleware of an IoT edge device generating a super service recognizes that one service constituting the super service fails to run (e.g., receives a notification of the failure from middleware of an IoT edge device), the middleware may check whether there is another IoT edge device providing the same service mapped by middleware without forwarding the corresponding result to the virtual IoT device, and then, when there is another IoT edge device, request the same service from the other IoT edge device.

When a corresponding service fails to run, execution of the super service is stopped as described above, and all other IoT edge devices providing the same service notify of the failure in processing the super service.

Since a plurality of identical IoT devices may be registered with different IoT edge devices or the same IoT edge device and used as described above, this may be processed in a distributed manner according to the present invention.

According to an aspect of the present invention, when a service of a lower layer constituting a super service is provided in the same way by a plurality of IoT edge devices, an IoT edge device processing the requested super service may request processing of the service such that the service constituting the super service may be executed by the plurality of IoT edge devices in a distributed manner.

When a specific service constituting a super service is requested from middleware of an IoT edge device generating the super service by a virtual IoT device executing the super service and a plurality of mapped IoT edge devices provide the specific service in the same way, it is possible to request processing of the service from the plurality of IoT edge devices in a distributed manner.

Here, even when the specific service of which distributed processing is requested fails to run, if there is another IoT edge device providing the same service mapped by middleware, the virtual IoT device executing the super service can request the same service from the other IoT edge device without stopping execution of the super service.

According to an aspect of the present invention, each IoT edge device 110 dynamically manages an execution state of a service provided by itself. Middleware of each IoT edge device 110 can monitor a state of a registered IoT device 120 and execution states of services provided by the IoT device 120 and dynamically manage the states.

Middleware of each IoT edge device 110 manages a state of the IoT edge device 110 such that an IoT device 120 may be dynamically added or removed. When an IoT device 120 is removed, the middleware may also remove services provided by the IoT device 120.

Middleware may generate and manage a service state table for managing states of services provided by IoT devices 120 registered with a corresponding IoT edge device 110. The middleware may manage service states as running and waiting to run. However, service states are not limited thereto, and other states may be added as necessary.

When execution of a service registered with the middleware is requested, the middleware checks an execution state of the service in the service state table. When the execution state of the service is waiting to run, the middleware forwards the service execution request to a mapped IoT device 120 and changes the execution state of the service to running in the service state table. Subsequently, when the IoT device 120 executing the service notifies the middleware that the execution has been completed, the middleware changes the execution state of the service to waiting to run in the service state table.

Middleware of an IoT edge device 110 in a higher layer may transmit a service execution state report request to identify an execution state of a service provided by an IoT edge device 110 in a lower layer.

When the service execution state report request is received from the IoT edge device 110 in the higher layer, the middleware of the IoT edge device 110 searches the service state table for the corresponding service and then reports the execution state in response to the request.

In the IoT edge system 10 of the present invention, middleware of an IoT edge device 110 in a higher layer can request execution of a service published by an IoT edge device 110 in a lower layer. Whether the service is currently executable is managed by an IoT edge device 110 with which the service has been registered using a service state table. Even when the service is published, the IoT edge device 110 having an access right in the higher layer rather than the IoT edge device 110 with which the service has been registered does not directly manage a state of the service. Therefore, the IoT edge device 110 in the higher layer requests the service without being aware of whether the published service in the lower layer is executable, which leads to an unnecessary request when the service is inexecutable.

The IoT edge device 110 in the higher layer that requests execution of a service published by the IoT edge device 110 in the lower layer may check availability of the service from the IoT edge device 110 in the lower layer before requesting execution of the service. Here, the middleware of the IoT edge device 110 in the higher layer may transmit a service execution state report request to the middleware of the IoT edge device 110 in the lower layer and receive the result to check the availability of the service.

As described above, according to an aspect of the present invention, each IoT edge device 110 can dynamically manage execution states of services provided by itself. Middleware of each IoT edge device 110 can monitor a state of a registered IoT device 120 and execution states of services provided by the IoT device 120 and dynamically manage the states.

An IoT edge device 110 executing a super service can check availability of all services constituting the super service and then start executing the super service.

Middleware of the IoT edge device 110 executing the super service can check availability of all services constituting the super service by requesting service execution state reports from IoT edge devices 110 with which IoT devices 120 mapped to the services have been registered, and then, when it is determined that all the services are available, can execute the super service.

An IoT edge system of the present invention can be easily extended by connecting edge-based IoT platforms in a tree-shaped hierarchical structure.

In addition, according to an IoT edge system of the present invention, middleware of a higher layer in a hierarchical structure utilizes a service published by middleware of a lower layer to generate and share a new high-level service.

Various exemplary embodiments disclosed in the present specification and the drawings merely present specific examples of the present invention to aid in understanding and are not intended to limit the scope of various embodiments of the present invention.

Therefore, the scope of various embodiments of the present invention should be construed to encompass all altered or modified forms derived from the technical spirit of various embodiments of the present invention in addition to the exemplary embodiments described herein.

What is claimed is:

1. An Internet of Things (IoT) edge system in which IoT edges having a hierarchical structure share resources, the IoT edge system comprising:
a plurality of IoT devices, each configured to register a list of providable services with an IoT edge device in a same network and receive service execution requests from the IoT edge device to process the service execution requests; and
a plurality of IoT edge devices, each of which includes middleware that registers and manages services provided by at least one IoT device in the same network, sets whether to publish the registered services, and determines whether to provide a requested service based on an access rights when another IoT edge device requests the service,
wherein the plurality of IoT edge devices form a tree-shaped hierarchical structure,
an IoT edge device having a higher layer forwards a list of published services to an IoT edge device in the higher layer, and
the IoT edge device in the higher layer has the rights to access the services published by the IoT edge device in a lower layer.

2. The IoT edge system of claim 1, wherein the IoT edge device in the higher layer generates a super service by combining a service registered with the IoT edge device with a service published by the IoT edge device in the lower layer or combining services published by the IoT edge device in the lower layer.

3. The IoT edge system of claim 2, wherein the IoT edge device generating the super service sets the super service public and forwards the generated super service to IoT edge devices in the lower layer of the IoT edge device.

4. The IoT edge system of claim 2, wherein the IoT edge device generating the super service generates a virtual IoT device which configured to execute the super service, registers the virtual IoT device with middleware of the IoT edge device, and when a super service request is received, executes the super service through the virtual IoT device to process the service.

5. The IoT edge system of claim 4, wherein, when failing to execute one service constituting the super service, the IoT edge device processing the requested super service stops execution of the super service and notifies an IoT edge device which has requested the super service of the failure in processing the super service.

6. The IoT edge system of claim 4, wherein, when the IoT edge device which processes the requested super service fails to execute a service constituting the super service and the same service is provided by another IoT edge device, the IoT edge device requests execution of the service that the IoT edge device has failed to execute from the other IoT edge device which provides the same service.

7. The IoT edge system of claim 4, wherein, when a service constituting the super service is provided in the same way by a plurality of IoT edge devices, the IoT edge device processing the requested super service requests processing of the service such that the service constituting the super service is executed by the plurality of IoT edge devices in a distributed manner.

8. The IoT edge system of claim 1, wherein each of the IoT edge devices dynamically manages an execution state of a service provided by the IoT edge device and reports the execution state in response to a service execution state report request received from an IoT edge device in a higher layer.

9. The IoT edge system of claim 8, wherein the IoT edge device in the higher layer that requests execution of the service published by the IoT edge device in the lower layer checks availability of the service from the IoT edge device in the lower layer before requesting the execution of the service.

10. The IoT edge system of claim 2, wherein an IoT edge device that dynamically manages an execution state of a service provided by the IoT edge device and executes the super service checks availability of all the services constituting the super service and then starts executing the super service.
